(19) United States
(12) Patent Application Publication
(10) Pub. No.: US 2019/0019352 A1
(43) Pub. Date: Jan. 17, 2019

(54) BOAT MONITORING AND TRACKING

(71) Applicant: Siren Marine LLC, Newport, RI (US)

(72) Inventor: Daniel A. Harper, Newport, RI (US)

(21) Appl. No.: 16/034,068

(22) Filed: Jul. 12, 2018

Related U.S. Application Data
(60) Provisional application No. 62/531,849, filed on Jul. 12, 2017.

(51) Int. Cl. G07C 5/00; B63J 99/00

(52) U.S. Cl. CPC G07C 5/008; B63J 2099/006; B63J 99/00

(57) ABSTRACT

A system includes a base unit mounted securely within a boat, one or more sensors, each of the one or more sensors positioned throughout the boat and communicatively linked to the base unit, a web application residing in a server, the base unit communicatively linked to the web application, and a remote device, the remote device communicatively linked to the web application in the server, the web application configured to provide input

### CROSS REFERENCE TO RELATED APPLICATIONS

This application claims benefit from U.S. Provisional Patent Application Ser. No. 62/531,849, filed Jul. 12, 2017, which is incorporated by reference in its entirety.

### STATEMENT REGARDING GOVERNMENT INTEREST

None.

### BACKGROUND OF THE INVENTION

The present invention is generally directed towards information exchange, and more specifically to a boat monitoring and tracking system.

In general, a marine vessel, such as a ship or boat, includes one or more operational systems to insure smooth operation. These systems can include, for example, batteries, bilge pumps, location tracking and positioning devices, security systems, and so forth. Moreover, each year, thousands of insurance claims are made for items stolen from boats and for boats that have sunk or been damaged, that could have been easily avoided with the installation of a boat monitoring system.

What is needed is a single system that can monitor all marine operational systems and provide alerts when necessary to insure proper and safe operation of the marine vessel.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a system including a base unit mounted securely within a boat, one or more sensors, each of the one or more sensors positioned throughout the boat and communicatively linked to the base unit, a web application residing in a server, the base unit communicatively linked to the web application, and a remote device, the remote device communicatively linked to the web application in the server, the web application configured to provide input and output to the base unit and to the remote device, the remote device comprising at least a processor, a memory and a display, the memory comprising at least an operating system and an app, the app configured to generate one or more graphical user interfaces on the display to enable interaction between the remote device and the base unit though the web application to receive from and send communications to the one or more sensors positioned throughout the boat.

In another aspect, the invention features a system including a boat monitoring subsystem, a server, and an end-user subsystem, the server communicatively linked to the boat monitoring subsystem and the end-user subsystem, server including at least a processor, a memory and a data store, the memory including at least an operating system and a web application, the web application configured to received and transmit input and output between the boat monitoring subsystem and the end-user subsystem.

In still another aspect, the invention features a method including providing one or more sensors positioning in areas of a marine watercraft, receiving an output from the one or sensors in a base unit, sending the received output from the base unit to a web server, analyzing the received output in the web server, and transmitting a notification to a remote monitoring unit based on the analyzed received output.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a block diagram of an exemplary architecture.

FIG. 2 is a block of an exemplary system.

FIG. 3 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Although the present invention will be described in the context of boat monitoring, the principles described may be adapted to monitoring other types of vehicles.

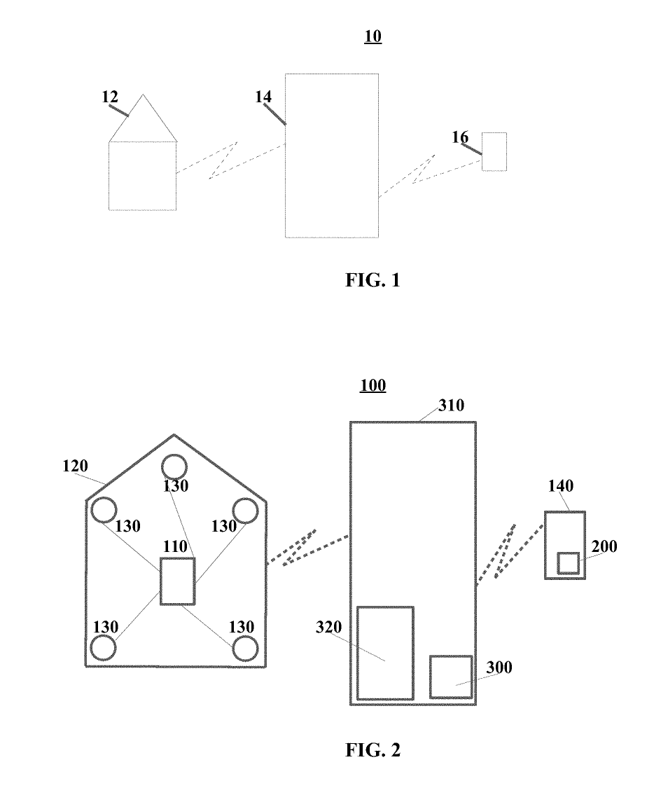

As shown in FIG. 1, an exemplary system architecture 10 of the present invention includes a watercraft 12, such as a boat, a web server 14 and a remote electronic device 16, such as a smartphone, laptop, tablet computer, personal data assistant (PDA)) or personal computer (PC). The system architecture 10 enables boat monitoring and tracking. More specifically, the system architecture 10 enables transmission of information generated from the boat 12 to the remote electronic device 16 through the web server 14 and communication from the remote electronic device 16 to the boat 12 through the web server 14.

As shown in FIG. 2, an exemplary boat monitoring and tracking system 100 includes a base unit 110. The base unit 110 is mounted securely within a boat 120. Preferably, the base unit 110 is constructed of marine grade plastic. The boat monitoring and tracking system 100 includes one or more sensors, generally referred as 130, positioned throughout the boat 120. The one or more sensors 130 are communicatively linked to the base unit 110. These links between the base unit 110 and the one or more sensors 130 may be wired or wireless. The one or more sensors 130 are connected to one or more devices on the boat 120, such as for example, a battery, a bilge pump, a Global Positioning System (GPS) unit, a security unit, a shore power unit, an ignition gauge, an oil pressure gauge and so forth.

The boat monitoring and tracking system 100 also includes a remote electronic device 140. The remote electronic device 140 may be a laptop computer, desktop computer, tablet computer, smartphone, and so forth. In a preferred embodiment, the remote electronic device 140 is an Android® or iOS® smartphone. The remote electronic device 140 includes a boat monitoring and tracking application (“app”) 200. The boat monitoring and tracking app 200 interacts with a web application 300 residing in a web server 310. In addition, information generated from the one or more sensors 130 is transmitted from the base unit 110 to the web application 300. Thus, a user of the boat monitoring and tracking app 200 can interact with the base unit 110, sending instructions to the base unit 110 or receiving information from the base unit 110. More specifically, the boat monitoring and tracking application app 200 is configured to generate a series of graphical user interfaces (GUIs) on the remote electronic device 140 to enable a user to interact with the web application 300, and thus with the base unit 110.

Data from the sensors 130 is collected by the base unit 110, transmitted to the boat monitoring and tracking application app 200, and displayed to the user. In addition, the boat monitoring and tracking application app 200 enables a user to interactively view visual data and enter commands to control one or more of the sensors 130.

The web application 300 is configured to transmit alerts received from the base unit 110. The received alerts can then be communicated to the remote electronic device 140. The web application 300 is configured to analyze the generated alerts and transmits selected ones to the remote electronic device 140. Analyzing the generated alerts can include one or more of identifying a type of alert, identifying a number of the type of alert and/or comparing the generated alert to a threshold.

Information received by the web application 300 from the base unit 110 and/or remote electronic device 140 can be stored in database 320 residing in the web server 310. This stored information may be used for further processing or report generation. Moreover, information stored by the web server 310 may be viewed by the user to determine a state of the boat 120 at any point in time.

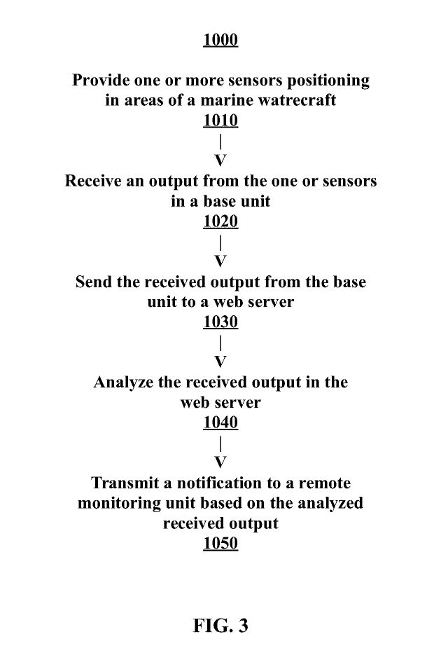

In FIG. 3, a process 1000 includes providing (1010) one or more sensors positioning in areas of a marine watercraft.

Process 1000 receives (1020) an output from the one or sensors in a base unit.

Process 1000 sends (1030) the received output from the base unit to a web server.

Process 1000 analyzes (1040) the received output in the web server.

Process 1000 transmits (1050) a notification to a remote monitoring unit based on the analyzed received output.

In summary, a user can view information about the state of their boat, send commands to the boat and received alerts from the boat.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A system comprising:
a base unit mounted securely within a boat;
one or more sensors, each of the one or more sensors positioned throughout the boat and communicatively linked to the base unit;
a web application residing in a server, the base unit communicatively linked to the web application; and
a remote device, the remote device communicatively linked to the web application in the server, the web application configured to provide input and output to the base unit and to the remote device,
the remote device comprising at least a processor, a memory and a display, the memory comprising at least an operating system and an app,
the app configured to generate one or more graphical user interfaces on the display to enable interaction between the remote device and the base unit though the web application to receive from and send communications to the one or more sensors positioned throughout the boat.

2. The system of claim 1 wherein the base unit collects and transmits data from the one or more sensors to the web application residing in the server.

3. The system of claim 2 wherein the collected data is stored in a database residing in the server.

4. The system of claim 2 wherein the collected data is displayed on the one or more graphical user interfaces of the remote device.

5. The system of claim 1 wherein the remote device enables command and control of the one or more sensors.

6. The system of claim 1 wherein the one or more sensors are connected to devices selected from the group consisting of a battery, a bilge pump, a Global Positioning System (GPS) unit, a security unit, a shore power unit, an ignition gauge and an oil pressure gauge.

7. The system of claim 1 wherein the web application is configured to transmit alerts generated from the base unit to the remote device.

8. A system comprising:
a boat monitoring subsystem;
a server; and
an end-user subsystem, the server communicatively linked to the boat monitoring subsystem and the end-user subsystem, server comprising at least a processor, a memory and a data store, the memory comprising at least an operating system and a web application, the web application configured to received and transmit input and output between the boat monitoring subsystem and the end-user subsystem.

9. The system of claim 8 wherein the boat monitoring subsystem comprises:
a base unit mounted securely within a boat; and
one or more sensors, each of the one or more sensors positioned throughout the boat and communicatively linked to the base unit.

10. The system of claim 9 wherein the one or more sensors are connected to devices selected from the group consisting of a battery, a bilge pump, a Global Positioning System (GPS) unit, a security unit, a shore power unit, an ignition gauge and an oil pressure gauge.

11. The system of claim 9 wherein the one or more sensors are configured to control, monitor and generate alerts from devices installed on the boat.

12. The system of claim 9 wherein the base unit is configured to transmit generated alerts to the web application.

13. The system of claim 12 wherein the web application is configured to analyze the generated alerts and transmits selected ones to the end-user subsystem.

14. The system of claim 12 wherein analyzing the generated alerts includes one or more of identifying a type of alert, identifying a number of the type of alert and/or comparing the generated alert to a threshold.

15. The system of claim 8 wherein the end-user subsystem is selected from the group consisting of a laptop computer, a desktop computer, a personal data assistant, a tablet computer and a smartphone.

16. The system of claim 8 wherein the end-user subsystem comprises:
a processor;
a memory, the memory comprising at least an operating system and a web browser, the web browser enabling interaction between the end-user subsystem and the web application; and
a display.

17. The system of claim 8 wherein the end-user subsystem comprises:
a display;
a processor; and
a memory, the memory comprising at least an operating system and an app, the app configured to display one or more graphical user interfaces on the display to enable communication between the end-user subsystem and the web application.

18. A method comprising:
providing one or more sensors positioning in areas of a marine watercraft;
receiving an output from the one or sensors in a base unit;
sending the received output from the base unit to a web server;
analyzing the received output in the web server; and
transmitting a notification to a remote monitoring unit based on the analyzed received output.
